(19) United States
(12) Patent Application Publication
(10) Pub. No.: US 2017/0324921 A1
(43) Pub. Date: Nov. 9, 2017

(54) METHOD AND DEVICE FOR DISPLAYING MULTI-CHANNEL VIDEO

(71) Applicant: MediaTek Singapore Pte. Ltd., Singapore (SG)

(72) Inventors: Xiaomeng YAN, Tianjin (CN); Chun-Chia CHEN, Hsinchu City (TW)

(21) Appl. No.: 15/586,560

(22) Filed: May 4, 2017

(30) Foreign Application Priority Data
May 6, 2016 (CN) 201610299366.2

(51) Int. Cl. H04N 5/445; G06T 7/73; G06K 9/00; H04N 5/72

(52) U.S. Cl. CPC H04N 5/44591; H04N 5/72; G06T 7/73; G06K 9/00268; G06T 2207/30201

(57) ABSTRACT

A multi-channel video display method and a multi-channel video display device thereof are provided. The multi-channel video display method includes receiving at least two video signals; obtaining position information for at least two users who are in front of a display screen of the electronic apparatus and who are browsing the video signals respectively, wherein each of the users corresponds to a respective video signal; adjusting, according to the position information of each of the users, the direction of a filter of the display screen of the electronic apparatus so that the display direction of the video signal only points toward the corresponding user; and simultaneously displaying the video signals according to the display directions of the video signals.

### CROSS REFERENCE TO RELATED APPLICATION

The present application is based on, and claims priority from, 201610299366.2, filed on, May 6, 2016, the invention of which is hereby incorporated by reference herein in its entirety.

### TECHNICAL FIELD

The disclosure relates to video display techniques, and more particularly to a multi-channel video display method, a multi-channel video display device and a multi-channel video display electronic system.

### BACKGROUND

Conventional split-view display techniques are mainly classified into two types. One is generally displaying a small screen (sub-screen) in a region such as the corner of a full screen (main screen) on top of a main screen, i.e. picture-in-picture. The disadvantage of this split-view display technique is that part of the main screen is blocked by the sub-screen. Another technique is to divide a screen into two split screens and to display two video signals on the two split screens. This will cause the original video being severely deformed, which may affect the viewing experience. Currently there is another split-view display technique which can simultaneously display multi-channel video signals on a screen without mutual interference and distortion. However, this split-view display technique only supports displaying videos in a specific directions.

With the development of video processing and electronic apparatuses, a technique which can support the simultaneous display of multi-channel video signals at full screen is generated. FIG. 1 shows a schematic diagram of a method for simultaneously displaying multi-channel video signals in the prior art. The principle is splitting the pixels of two (or multiple) different screens and then rearranging the pixels on the screen in a “staggered” manner. Then a filter cover is added onto the screen. Light emitted from the pixels are refracted by the filter cover. Then light emitted from the staggered pixels are separated into two independent and complete screens after passing through the filter cover. The two screens have stronger directivity, and thus viewers in different directions can watch what they need without interference.

However, as described above, the two separately displaying video screens only point in specific directions during the split-view of the multi-channel video display method. If the user changes his position, the user cannot watch the video screen and this leads to poor flexibility and reliability of the split-view display.

### SUMMARY

In view of this, a multi-channel video display method is required to recognize the positions of users and thereby adjust the display content so that the user can watch a corresponding video screen anytime and anywhere.

The present invention provides a multi-channel video display method and a multi-channel video display device to overcome the problems mentioned above.

In one embodiment, a multi-channel video display method applied to an electronic apparatus is provided. The multi-channel video display method comprises receiving at least two video signals; obtaining position information for at least two users who are in front of a display screen of the electronic apparatus and browsing videos, wherein each user corresponds to at least two respective video signals; adjusting, according to the position information of each of the at least two users, the direction of a filter of the display screen of the electronic apparatus so that the display direction of each of the at least two video signals only points toward the corresponding user; and simultaneously displaying the at least two video signals according to the display directions of the at least two video signals.

Furthermore, obtaining the position information of the users of the multi-channel video display method comprises capturing pictures of the users' faces within a predetermined time interval; extracting facial features of each of the users from the pictures of the users' faces; and determining, according to the facial features of each of the users, the position information of each of the users in front of the display screen of the electronic apparatus.

Furthermore, the multi-channel video display method further comprises capturing pictures of the users' faces within a predetermined time interval; extracting facial features of each of the users from the pictures of the users' faces; comparing the facial features of each of the users with previously stored facial fiducials of each of the users to detect whether each of the users is in a state of rest or not; and stopping the output of the video signal corresponding to the user in the state of rest when the user is detected.

Furthermore, in adjusting the direction of the filter of the display screen of the electronic apparatus according to the position information of each of the users so that the display direction of the video signal only points toward the corresponding user, the multi-channel video display method further comprises connecting to an electronic apparatus of each of the users; and jointly displaying communication messages transmitted by the electronic apparatuses of the users and the video signal corresponding to the user on the screen when receiving the communication messages, wherein the display direction of the communication messages only points toward the corresponding user.

In another embodiment, a multi-channel video display device is provided. The multi-channel video display device comprises a video receiving module, a tracking module, an adjustment module and an output module. The video receiving module is configured to receive at least two video signals. The tracking module is configured to obtain position information for at least two users who are in front of a display screen of the electronic apparatus and are browsing videos signals respectively, wherein each of the at least two users corresponds to one of the video signals. The adjustment module is configured to adjust, according to the position information of each of the at least two users, a direction of a filter of the display screen of the electronic apparatus so that the display direction of each of the video signals only points toward the corresponding user. The output module is configured to simultaneously display the video signals according to the display directions of the video signals.

Furthermore, the multi-channel video display device further comprises a first collection module and a first extraction module. The first collection module is used to capture pictures of the users' faces within a predetermined time interval. The first extraction module is used to extract facial features of each of the users from the pictures of the users' faces. The tracking module is used to determine, according to the facial features of each of the users, the position information of each of the users in front of the display screen of the electronic apparatus.

Furthermore, the multi-channel video display device further comprises a second collection module, a second extraction module and a comparison module. The second collection module is used to collect pictures of the users' faces within a predetermined time interval. The second extraction module is used to extract facial features of each of the users from the pictures of the users' faces. The comparison module is used to compare the facial features of each of the users with previously stored facial fiducials of each of the users to detect whether each of the users is in a state of rest or not. The adjustment module is further used to stop outputting the video signal corresponding to the user in the state of rest when the user is detected.

Furthermore, the multi-channel video display device further comprises a communication module. The communication module is used to connect to an electronic apparatus of each of the users. The output module is used to jointly display communication messages transmitted by the electronic apparatuses of the users and the video signal corresponding to the user on the screen when receiving the communication messages, wherein the display direction of the communication messages only points toward the corresponding user.

An embodiment of the present invention further provides an electronic apparatus. The electronic apparatus comprises the above multi-channel video display devices.

According to the multi-channel video display method, the multi-channel video display device , position information for at least two users (who are in front of a display screen of the electronic apparatus and who are browsing through videos) is obtained and then the direction of a filter of the display screen of the electronic apparatus is adjusted according to the position information of each of the users so that the display direction of each of the video signals only points toward the corresponding user.

In the technical solutions provided in the present invention, a user's position in front of a display screen of an electronic apparatus is obtained to adjust a filter of the display screen of the electronic apparatus so that different video signals only point in the directions of the corresponding users. The direction that the video signals are facing may be changed by the movement of the user so that the user can watch the video screen in different positions. The problems that exist in current split-view display techniques wherein two separately displayed video screens can only point in specific directions are overcome. Accordingly, the flexibility and reliability of split-view displays is improved.

### BRIEF DESCRIPTION OF THE DRAWINGS

In order to more clearly illustrate technical solutions in embodiments of the present invention or current technology, figures used in the embodiments or current technology are briefly introduced below. Obviously, the figures described below are some embodiments of the present invention. Those skilled in the art can obtain other figures without creative efforts according to the figures described below.

FIG. 1 shows a schematic diagram of simultaneously displaying multi-channel video signals in the prior art.

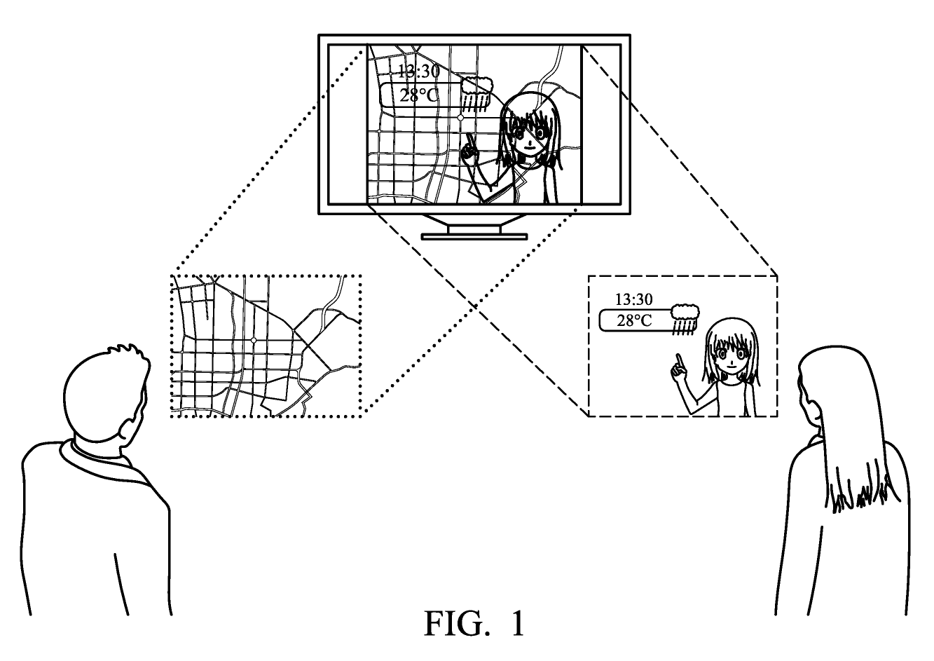

FIG. 2 shows a flow diagram of a multi-channel video display method according to another embodiment of the present invention.

FIG. 3 shows a flow diagram of a multi-channel video display method according to another embodiment of the present invention.

FIG. 4 shows a flow diagram of a multi-channel video display method according to another embodiment of the present invention.

FIG. 5 shows a flow diagram of a multi-channel video display method according to another embodiment of the present invention.

FIG. 6 shows a schematic diagram of a multi-channel video display device according to an embodiment of the present invention.

FIG. 7 shows a schematic diagram of a multi-channel video display device according to another embodiment of the present invention.

FIG. 8 shows a schematic diagram of a multi-channel video display device according to another embodiment of the present invention.

FIG. 9 shows a schematic diagram of a multi-channel video display device according to another embodiment of the present invention.

### DETAILED DESCRIPTION

The present invention can be more fully understood by reading the subsequent detailed description and examples with references made to the accompanying drawings

It should be certain that the embodiments described below are only part of embodiments of the present invention but not all embodiments. Based on embodiments of the present invention, all of other embodiments obtained by the person skilled in the art without creative efforts belong to the scope of the present invention.

The terminology used in the embodiments of the present invention s only used for the purpose of describing specific embodiments and is not taken in a limiting sense. Unless the context clearly dictates other meanings, the singular forms “a” and “the” used in the embodiments and claims of the present invention are also intended to comprise the plural form.

It should be understood that the terms “and/or” used in the specification are only describing a relationship of associated objects and can be interpreted as three relationships, for example, A and/or B can be interpreted as three situations: A exists independently; both A and B exist; B exists independently. In addition, a character “/” used in the specification generally represents the context such as a relation of “or”.

The word “if” used herein depends on the context and can be interpreted as “In the . . . ”, “when . . . ”, “in response to determining” or “in response to detecting”. Similarly, The phrase “If it is determined” or “If it is detected (stated condition or event)” used herein depends on the context and can be interpreted as “When it is determined”, “in response to determining”, “when the detected (stated condition or event)” or “in response to detecting (stated condition or event)”.

### EMBODIMENT 1

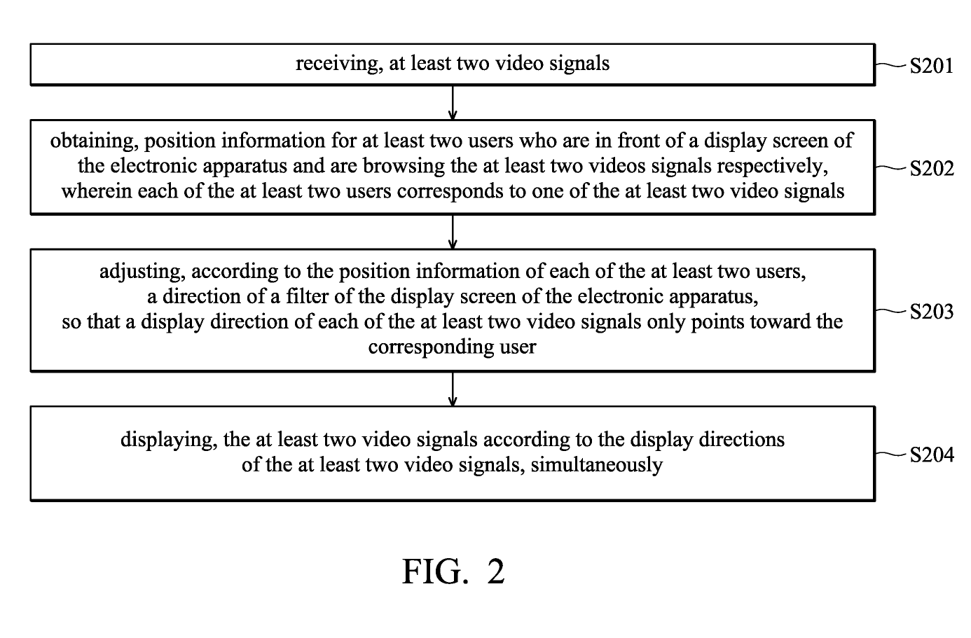

FIG. 2 shows a flow diagram of a multi-channel video display method according to an embodiment of the present invention. As shown in FIG. 2, the multi-channel video display method of the present embodiment specifically comprises the following steps:

In step S201, at least two video signals are received.

Specifically, when multiple users view the video, different users would like to view different video signals. Accordingly, multi-channel video signals are transmitted to a display screen of an electronic apparatus. The electronic apparatus (such as a television set) receives the multi-channel video signals, and the electronic apparatus performs image processing on the multi-channel video signals to simultaneously output at least two video signals through current filtering techniques or coding techniques.

It should be noted that the present invention is not limited to the television. In other embodiments of the present invention, the electronic apparatus displaying the multi-channel video signals also can be an advertising screen, a computer, or a vehicle display apparatus.

In step S202, position information is obtained for at least two users who are in front of a display screen of the electronic apparatus browsing videos, wherein each of the users corresponds to one of the video signals, respectively.

Specifically, the position of the user may change while the user is viewing the video. For example, with respect to the display screen of the vehicle display apparatus, when the users exchange seats, the position information of the users in front of the display screen of the vehicle display changes. Or, in another example, when a user adjusts his sitting position, the position information of the user in front of the display screen of the vehicle display apparatus changes. Accordingly, in the present invention, position information for at least two users (who are in front of a display screen of the electronic apparatus and who are browsing the videos) is obtained periodically or in real-time for tracking the users. And further display angles of the video signals being played are adjusted according to the position information. As a result, after the position information of the users in front of the display screen of the electronic apparatus changes, the user still can view the video that he wants to view.

It should be appreciated that, in the present invention, at least two video signals are received and there are at least two users. Accordingly, each of the users corresponds to one of the video signals.

In step S203, the direction of the filter of the display screen of the electronic apparatus is adjusted according to the position information of each of the users so that the display direction of each of the video signals only points toward the corresponding user.

Specifically, the filter is disposed in the display screen that displays the video signals. Changes of the position of the user in front of the display screen of the electronic apparatus can be obtained in step S202. When the positions of the users in front of the display screen of the electronic apparatus change, the filter disposed in the display screen is adjusted so that the display direction of each of the video signals only points toward the corresponding user.

For example, if the user changes from a seated position to a supine position while viewing the video, the filter is adjusted so that the video is displayed to point to only the user. The multi-channel video display method of the present invention adjusts display angles of the direction of the video signals so that the display direction of each of the video signals only points toward the corresponding user whose position has changed, and the user can view the video in different positions in front of the display screen of the electronic apparatus.

It should be noted that the present invention is not limited to using the filter of the display screen to filter the video signals. A glasses-type filter may also be used. For example, the user can wear 3D glasses with a filter function to view the video.

In step S204, the video signals are simultaneously displayed according to the display directions of the video signals.

Specifically, after the filter direction of the display screen of the electronic apparatus is adjusted, the video signals are simultaneously displayed according to the display direction of each of the video signals. As a result, the display direction of each of the video signals only points to the direction that the corresponding user is located so that each of the users can view the corresponding video without interference.

The multi-channel video display method of the present invention adjusts the filter of the display screen of the electronic apparatus by obtaining the position of the user who is in front of the display screen of the electronic apparatus so that each of the different video signals only points to the direction where the corresponding user is located. The direction in which the video signal is facing moves along with the movement of the user. The user can watch the video from different positions. This avoids problems in the prior art with the user not being able to see the video due to changes in his position. Accordingly, the flexibility and reliability of the split-view improves.

### EMBODIMENT 2

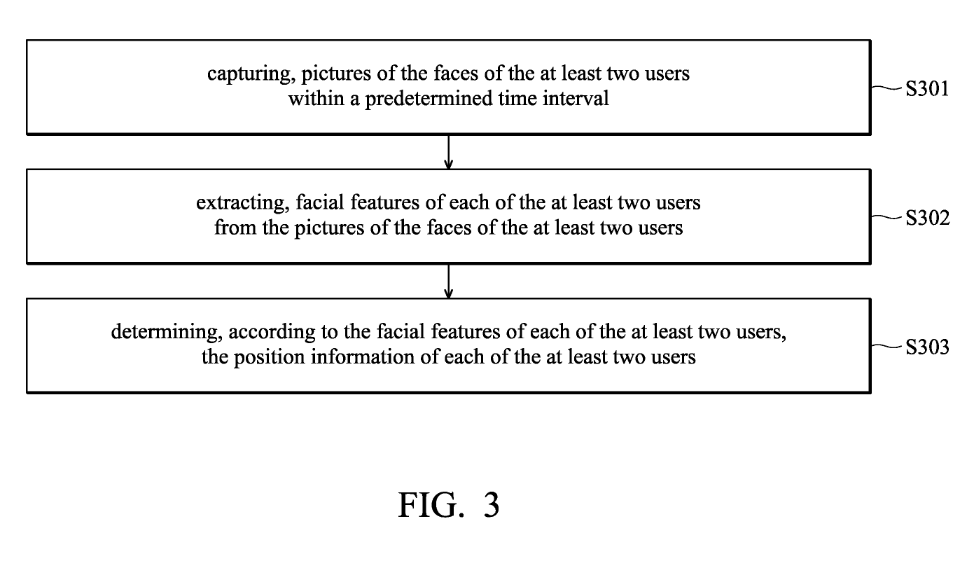

FIG. 3 shows a flow diagram of a multi-channel video display method according to another embodiment of the present invention. The present embodiment further describes a specific implementation of step S202 of the previous embodiment 1 in detail. As shown in FIG. 3, the present embodiment specifically comprises the following steps:

In step S301, pictures of the users' faces are captured within a predetermined time interval.

Specifically, in realistic scenarios, a camera can be disposed above the display screen of the electronic apparatus. The camera is used to capture pictures of the users. Then the picture of each user's face is divided to obtain the captured picture.

In step S302, facial features of each of the users are extracted from the pictures of the users' faces.

Specifically, the picture of each user's face obtained in step S301 is analyzed to extracting the facial features of each of the users.

In step S303, the position information of each of the users in front of the display screen of the electronic apparatus is determined according to the facial features of each of the users.

Specifically, the facial features of each of the users are compared with previously stored facial fiducials of each of the users by capturing the picture of the face of each user viewing the video. It is determined whether the position of each of the users in front of the display screen of the electronic apparatus changes or not according to the comparison result.

When it is determined that the position of the user in front of the display screen of the electronic apparatus has changed, the display angle of the video signal is required to be adjusted so that each of the different video signals only point to the direction in which the corresponding user whose position has changed is located. Then the user can watch the video from different positions in front of the display screen of the electronic apparatus.

### EMBODIMENT 3

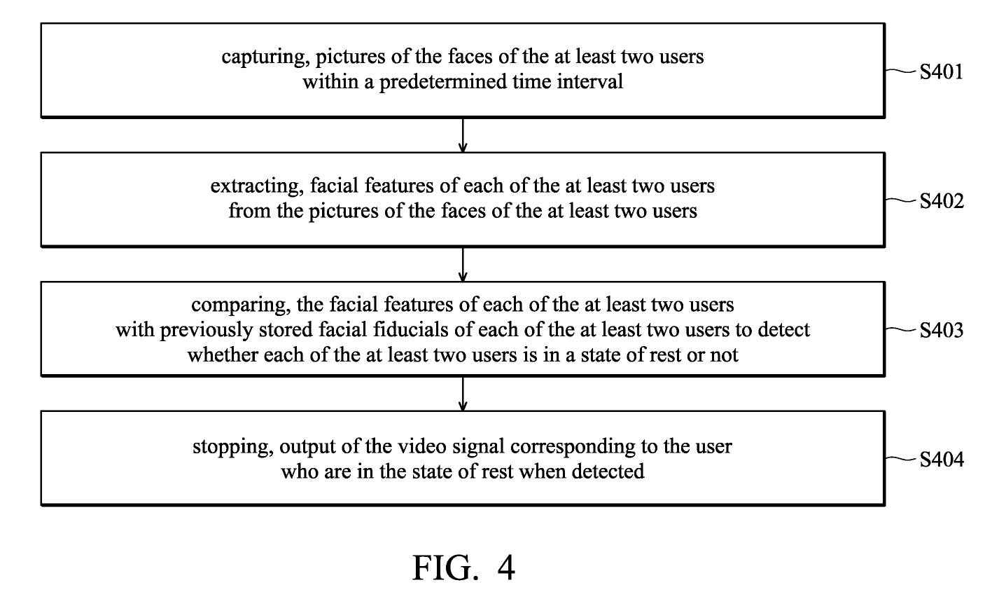

FIG. 4 shows a flow diagram of a multi-channel video display method according to another embodiment of the present invention. The present embodiment is an optional implementation based on embodiment 1. As shown in FIG. 4, the present embodiment specifically comprises the following steps:

In step S401, pictures of the users' faces are captured within a predetermined time interval.

Specifically, since the position of the user in front of the display screen of the electronic apparatus can change, the pictures of the face of each of the users in front of the display screen of the electronic apparatus can be captured periodically or in real-time.

For example, the picture of each user's face is captured periodically, at every 2 seconds time interval.

In step S402, the facial features of each of the users are extracted from the pictures of the users' faces.

Specifically, in order to determine the status of the user in front of the display screen of the electronic apparatus, the facial features of each of the users is extracted from the picture of each user's face.

Preferably, eye features of each of the users are extracted to determine whether the eyes of the user are closed or open.

In step S403, the facial features of each of the users are compared with previously stored facial fiducials of each of the users to detect whether each of the users is in a state of rest or not.

Specifically, default facial fiducials of each of the users is obtained. Then the facial features of each of the users are compared with the previously stored facial fiducials of each of the users to detect whether the eyes of the user are closed or not. If the eyes of the user are closed, the user is determined to be in a state of rest. Otherwise, if the eyes of the user are open, the user is determined to not be in a state of rest.

For example, the eye features of each of the users are compared with default eye features wherein the user's eyes are closed. If the degree of similarity between these two features is greater than a determined threshold, the eyes of the user are determined to be closed.

In step S404, the output of the video signal corresponding to the user in the state of rest is stopped when the user is detected to be in a state of rest.

Specifically, when the user is in a state of rest, the video corresponding to the user in the state of rest is closed according to a default correspondence between the user and the video so as not to affect the user.

The multi-channel video display method of the present invention can take a picture of the user's face in real-time and determine whether the user is resting or not according to the facial features of the user extracted from the picture of the user. When the user is in a rest state, the video corresponding to the user is turned off so as to affect the user, and user experience is thereby improved.

### EMBODIMENT 4

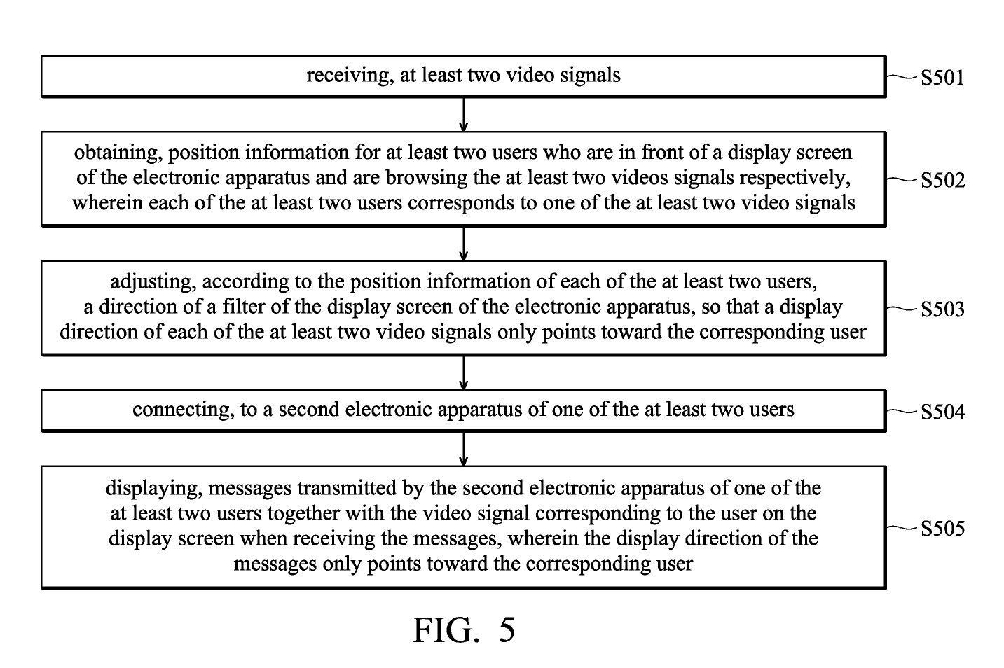

FIG. 5 shows a flow diagram of a multi-channel video display method according to another embodiment of the present invention. The present embodiment is an optional implementation based on the embodiment 1. As shown in FIG. 5, the present embodiment specifically comprises the following steps:

In step S501, at least two video signals are received.

Specifically, when multiple users view the video, different users would like to view different video signals. Accordingly, multi-channel video signals are transmitted to a display screen of an electronic apparatus. The electronic apparatus (such as a television set) receives the multi-channel video signals, and the electronic apparatus performs image processing on the multi-channel video signals to simultaneously output at least two video signals through current filtering techniques or coding techniques.

It should be noted that the present invention is not limited to the television. In other embodiments of the present invention, the electronic apparatus displaying the multi-channel video signals also can be an advertising screen, a computer, or a vehicle display apparatus.

In step S502, position information is obtained for at least two users who are in front of a display screen of the electronic apparatus browsing video signals, wherein each of the users corresponds to one of the video signals, respectively.

Specifically, position of the user changes while the user is viewing the video. For example, with respect to the display screen of the vehicle display apparatus, when the users exchange their seats, the position information of the users in front of the display screen of the vehicle display apparatus changes. Or, in another example, when a user adjusts his sitting position, the position information of the user in front of the display screen of the vehicle display apparatus changes. Accordingly, in the present invention, position information for at least two users (who are in front of a display screen of the electronic apparatus browsing videos) is obtained periodically or in real-time for tracking the users. And further display angles of played video signals are adjusted according to the position information. As a result, after the position information of the users in front of the display screen of the electronic apparatus changes, the user still can view the video that he wants to view.

It should be appreciated that, in the present invention, at least two video signals are received and there are at least two users. Accordingly, each of the users corresponds to one of the video signals.

In step S503, the direction of the filter of the display screen of the electronic apparatus is adjusted according to the position information of each of the users, so that the display direction of each of the video signals only points toward the corresponding user.

Specifically, the filter is disposed in the display screen that displays the video signals. Position changes of the user in front of the display screen of the electronic apparatus can be obtained in step S202. When the positions of the users in front of the display screen of the electronic apparatus change, the filter disposed in the display screen is adjusted so that the display direction of each of the video signals only points toward the corresponding user.

For example, if the user changes from a sitting position to a supine position while viewing the video, the filter is adjusted so that the video is displayed to point to only the user. The multi-channel video display method of the present invention adjusts display angles of the video signals' direction so that the display direction of each of the video signals only points toward the corresponding user whose position has changed and the user can view the video in different positions in front of the display screen of the electronic apparatus.

It should be noted that the present invention is not limited to using the filter of the display screen to filter the video signals. A glasses-type filter may also be used. For example, the user can wear 3D glasses with a filter function to view the video.

In step S504, an electronic apparatus of each of the users is connected.

In the specific implementation, an electronic apparatus used to display the video is connected by wire or wirelessly to an electronic apparatus of the user such as a telephone or a tablet.

In step S505, messages transmitted by the electronic apparatuses of the users are displayed together with the video signal corresponding to the user are on the screen when messages are received, wherein the display direction of the communication messages only points toward the corresponding user.

Specifically, if the electronic apparatus of the user receives communication messages such as a call, messages, or new e-mails while the user is viewing the video, and the electronic apparatus is in a mute status or the electronic apparatus is far away from the display screen so that the user cannot get the communication messages immediately. Meanwhile, a prompt box can be displayed on the electronic apparatus used to display the video and the communication messages are displayed through the prompt box.

The user of the present embodiment can immediately and conveniently view the communication messages received by the electronic apparatus while viewing the video. Meanwhile, a multi-channel video display method is adopted to avoid displaying the content of the communication messages to other users. It should be noted that the above embodiments are not limited to being implemented individually; it can also be a combination of some of the above embodiments.

The present invention further provides apparatus embodiments which implement every step and method in the above embodiments of the method.

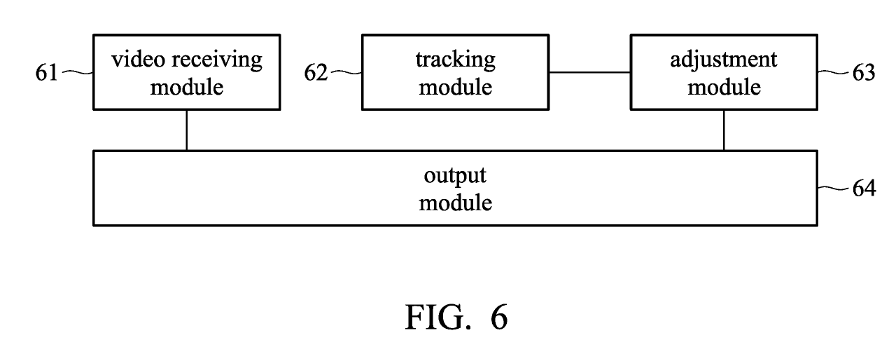

FIG. 6 shows a schematic diagram of a multi-channel video display device according to an embodiment of the present invention. As shown in FIG. 6, the multi-channel video display device comprises a video receiving module 61, a tracking module 62, an adjustment module 63, and an output module 64.

The video receiving module 61 is configured to receive at least two video signals;

The tracking module 62 is configured to obtain position information for at least two users who are in front of a display screen of the electronic apparatus and who are browsing the video signals, wherein each of the users corresponds to one of the video signals.

The adjustment module 63 is configured to adjust, according to the position information of each of the users, the direction of a filter of the display screen of the electronic apparatus so that the display direction of each of the video signals only points toward the corresponding user.

The output module 64 is configured to simultaneously display the video signals according to the display directions of the video signals.

Because each of the modules of the present embodiment can perform the method shown in FIG. 2, the related explanations in FIG. 2 can be referred to as a description of parts of the present embodiment which are not described in detail.

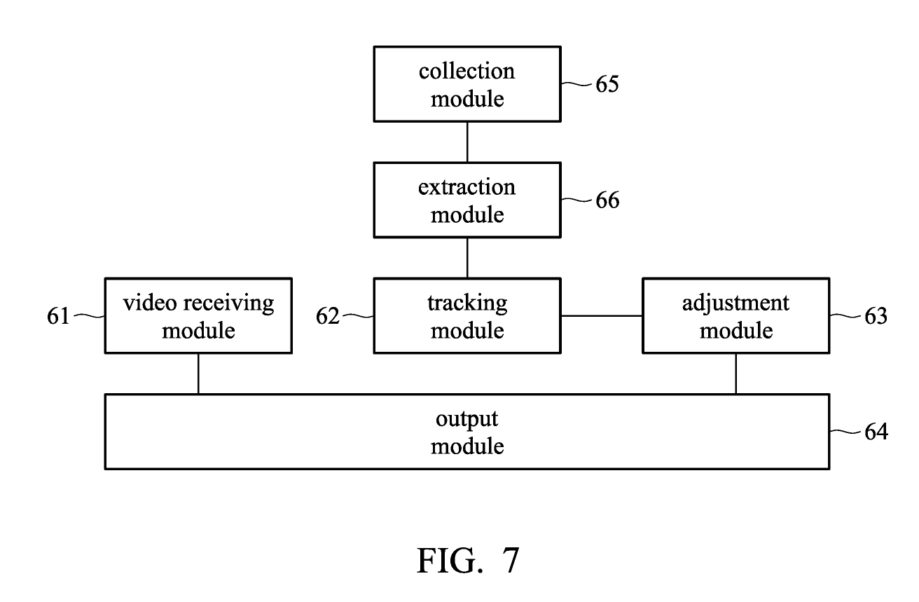

FIG. 7 shows a schematic diagram of a multi-channel video display device according to another embodiment of the present invention. As shown in FIG. 7, the multi-channel video display device further comprises a collection module 65 and an extraction module 66.

The collection module 65 is configured to capture pictures of the users' faces within a predetermined time interval, such as 1 minute and so on.

The extraction module 66 is configured to extract facial features of each of the users from the pictures of the users' faces.

The tracking module 62 is configured to determine, according to the facial features of each of the users, the position information of each of the users in front of the display screen of the electronic apparatus.

Because each of the modules of the present embodiment can perform the method shown in FIG. 3, parts of the present embodiment which are not described in detail can be referenced in the related explanations of FIG. 3.

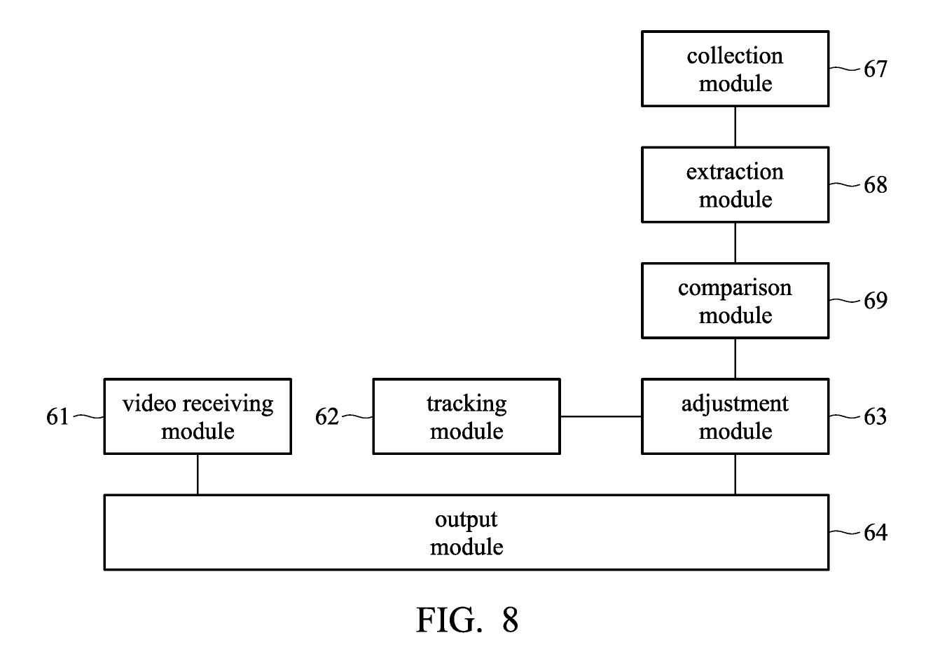

FIG. 8 shows a schematic diagram of a multi-channel video display device according to another embodiment of the present invention. As shown in FIG. 8, the multi-channel video display device of the present embodiment further comprises a collection module 67, an extraction module 68, and a comparison module 69.

The collection module 67 is configured to capture pictures of the users' faces within a predetermined time interval, such as 1 minute and so on.

The extraction module 68 is configured to extract facial features of each of the users from the pictures of the users' faces.

The comparison module 69 is configured to compare the facial features of each of the users with previously stored facial fiducials of each of the users to detect whether each of the users is in a state of rest or not.

The adjustment module 63 is further configured to stop outputting the video signal corresponding to the user in the state of rest when the user is detected.

Because each of the modules of the present embodiment can perform the method shown in FIG. 4, parts of the present embodiment which are not described in detail can be referenced in the related explanations of FIG. 4.

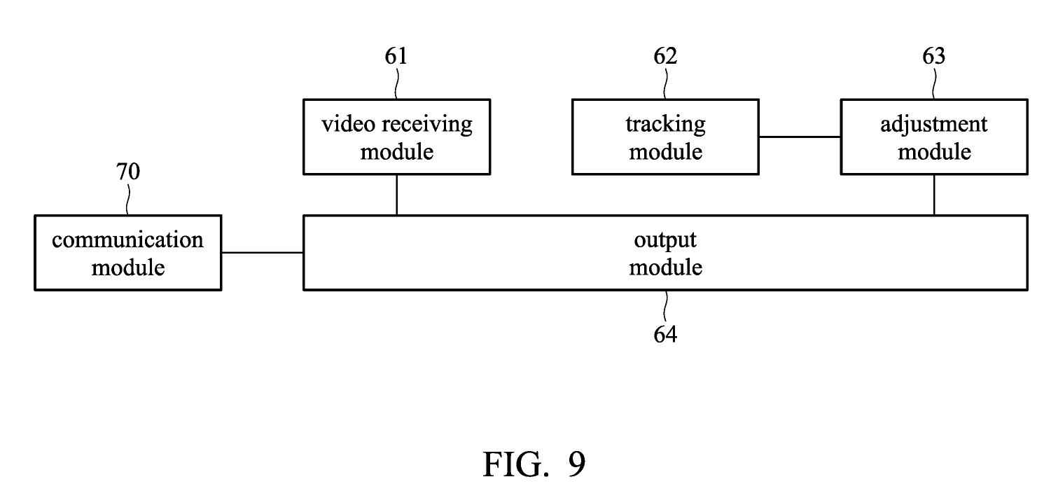

FIG. 9 shows a schematic diagram of a multi-channel video display device according to another embodiment of the present invention. As shown in FIG. 9, the multi-channel video display device of the present embodiment further comprises a communication module 70.

The communication module 70 is used to connect to an electronic apparatus of each of the users.

The output module 64 is used to display messages transmitted by the electronic apparatuses of the users together with the video signal corresponding to the user on the screen when receiving the messages, wherein the display direction of the communication messages only points toward the corresponding user.

Because each of the modules of the present embodiment can perform the method shown in FIG. 5, parts of the present embodiment which are not described in detail can be referred to the related explanations of FIG. 5.

The present invention further provides an electronic apparatus. The electronic apparatus comprises the multi-channel video display devices shown in FIGS. 6-9.

A person skilled in the art can clearly understand that, for convenience and brevity of description, a description of the specific work processes of the systems, devices and modules described above can be found by referring to the corresponding processes in the method in the embodiment described above and are not repeated here.

It should be understood that the system, device, and method disclosed in several embodiments provided in the present invention can be implemented in other ways. For example, the modules partitioned above are only a partition of logic functions. In actual implementation, there can be other ways of effecting that division. For example, multiple modules or components can be combined or captured in another system, or some features can be omitted, or not performed. In addition, the mutual coupling, direct coupling, or communication connection displayed or discussed herein can be accomplished through some interfaces. Indirect coupling or communication connection of devices or modules can be an electrical connection, a mechanical connection, or another form of connection.

The integrated unit above is implemented by a form of software functional unit that can be stored in a computer-readable storage medium. The software functional unit stored in the computer readable storage medium comprises several instructions used for a computer device (a personal computer, a server, a network device, etc.) or a processor performing part of the steps of the method described in each of the embodiments of the present invention. The computer-readable storage medium comprises a U disk, a removable hard disk, a read-only memory (ROM), a random access memory (RAM), a magnetic disk, CD-ROM, or any medium which can store program codes.

The foregoing is only preferred embodiments of the present invention but is not used to limit the present invention. Those skilled in the art will realize that such equivalent constructions do not depart from the spirit and scope of the present invention, and that they may make modifications, alterations, and improvements herein without departing from the spirit and scope of the present invention.

What is claimed is:

1. A multi-channel video display method, applied to an electronic apparatus, the method comprising:
receiving, at least two video signals;
obtaining, position information for at least two users who are in front of a display screen of the electronic apparatus and are browsing the at least two videos signals respectively, wherein each of the at least two users corresponds to one of the at least two video signals;
adjusting, according to the position information of each of the at least two users, a direction of a filter of the display screen of the electronic apparatus, so that a display direction of each of the at least two video signals only points toward the corresponding user; and
displaying, the at least two video signals according to the display directions of the at least two video signals, simultaneously.

2. The multi-channel video display method of claim 1, wherein obtaining the position information of the at least two users comprises:
capturing, pictures of the faces of the at least two users within a predetermined time interval;
extracting, facial features of each of the at least two users from the pictures of the faces of the at least two users; and
determining, according to the facial features of each of the at least two users, the position information of each of the at least two users.

3. The multi-channel video display method of claim 1, further comprising:
capturing, pictures of the faces of the at least two users within a predetermined time interval;
extracting, facial features of each of the at least two users from the pictures of the faces of the at least two users;
comparing, the facial features of each of the at least two users with previously stored facial fiducials of each of the at least two users to detect whether each of the at least two users is in a state of rest or not; and
stopping, output of the video signal corresponding to the user who are in the state of rest when detected.

4. The multi-channel video display method claims 1, further comprising:
connecting, to a second electronic apparatus of one of the at least two users; and
displaying, messages transmitted by the second electronic apparatus of one of the at least two users together with the video signal corresponding to the user on the display screen when receiving the messages, wherein the display direction of the messages only points toward the corresponding user.

5. A multi-channel video display device, comprising:
a video receiving module, for receiving at least two video signals;
a tracking module, for obtaining position information for at least two users who are in front of a display screen of the electronic apparatus and are browsing the at least two video signals respectively, wherein each of the at least two users corresponds to one of the at least two video signals;
an adjustment module, for adjusting, according to the position information of each of the at least two users, a direction of a filter of the display screen of the electronic apparatus, so that a display direction of each of the at least two video signals only points toward the corresponding user; and
an output module, for simultaneously displaying the at least two video signals according to the display directions of the video signals, simultaneously.

6. The multi-channel video display device of claim 5, further comprising:
a collection module, for capturing pictures of the faces of the at least two users within a predetermined time interval;
a extraction module ,for extracting facial features of each of the at least two users from the pictures of the faces of the at least two users; and
wherein the tracking module is further configured to determine, according to the facial features of each of the at least two users, the position information of each of the at least two users.

7. The multi-channel video display device of claim 5 further comprising:
a collection module, for capturing pictures of the faces of the at least two users within a predetermined time interval;
a extraction module, for extracting facial features of each of the at least two users from the pictures of the faces of the at least two users;
wherein the comparison module is further configured to compare the facial features of each of the at least two users with previously stored facial fiducials of each of the at least two users to detect whether each of the users is in a state of rest or not; and
wherein the adjustment module is further configured to stop outputting the video signal corresponding to the user who are in the state of rest when detected.

8. The multi-channel video display device of claim 5, further comprising:
a communication module, for connecting to an electronic apparatus of one of the users;
wherein the output module is configured to display messages transmitted by the electronic apparatus of one of the at least two users together with the video signal corresponding to the user on the display screen when receiving the messages, wherein the display direction of the messages only points toward the corresponding user.
